(19) United States
(12) Patent Application Publication
(10) Pub. No.: US 2024/0349217 A1
(43) Pub. Date: Oct. 17, 2024

(54) PHASE ERROR COMPENSATION FOR IOT OVER NTN

(71) Applicant: Nokia Technologies Oy, Espoo (FI)

(72) Inventors: Gilsoo LEE, Naperville, IL (US); Tzu-Chung HSIEH, Naperville, IL (US); Jingyuan SUN, Beijing (CN)

(21) Appl. No.: 18/579,393

(22) PCT Filed: Aug. 6, 2021
(86) PCT No.: PCT/CN2021/111358

§ 371 Date: Jan. 15, 2024

(51) Int. Cl. H04W 56/00; H04W 84/06

(52) U.S. Cl. CPC H04W 56/0045; H04W 56/0035; H04W 84/06

(57) ABSTRACT

This disclosure presents methods to compensate for a phase drift in an uplink communication signal between a user equipment (UE) and a non-terrestrial network (NTN) node. Due to the change rate of velocity of the UE relative to the NTN node, a transmission signal can drift causing demodulation errors at the receiver. The UE can apply compensation processes to the transmission signal so that the received signal is closer to the original transmitted signal as compared to a non-compensated signal. Alternatively, the NTN node can apply compensation process to modify the reference phase to be closer to the phase of the received signal in the demodulation process. The location of the UE, as well as its relative elevation, can be used with the NTN node's location, to generate the compensation information. The compensation can be applied on a symbol-by-symbol basis or to a group of M symbols.

### TECHNICAL FIELD

This application is directed, in general, to non-terrestrial network uplink communication signals and, more specifically, to compensating for timing advance drift of the communication signal.

### BACKGROUND

3GPP has agreed to study an item on Internet of Things (IoT) or enhanced machine type communication (eMTC) support for non-terrestrial networks (NTN) to provide IoT operation in remote areas, or in aero or space environments with low/no cellular connectivity for many different industries, such as transportation (maritime, road, rail, air, space) and logistics, solar, oil and gas harvesting, utilities, farming, environment monitoring, and mining. Satellite IoT or eMTC can be used in a complementary manner to terrestrial deployments where satellite connectivity can provide coverage beyond terrestrial deployments. In NTN systems, there may be long communication delays due to the distance between the UE and the NTN node. As a user equipment (UE) device moves relative to the NTN node, the distance between the UE and the NTN node can change causing a phase change in a transmitted signal. It would be beneficial to correct the phase error in the transmitted signal to improve the quality and reliability of the transmission.

### SUMMARY

In one aspect an apparatus is disclosed. In one embodiment, the apparatus includes (1) one or more processors, and (2) memory storing instructions and data that, when executed by the one or more processors, cause the apparatus to (1) estimate a timing advance (TA) drift rate, and (2) modify a communication signal from a user equipment (UE) to a non-terrestrial network (NTN) node to correct for a phase error caused by the TA drift rate.

In a second aspect, a method is disclosed. In one embodiment, the method includes (1) determining a device of an NTN to perform signal corrections on a communication signal between a transmitter and a receiver, wherein the transmitter is a UE, and the receiver is an NTN node, and (2) applying a phase compensation to the communication signal utilizing a timing advance (TA) drift rate.

In a third aspect, an NTN system is disclosed. In one embodiment, the NTN system includes (1) an NTN node, capable to transceive communications, and (2) a UE, capable to transceive communications with the NTN node, wherein a communication signal from the UE to the NTN node is corrected for a TA drift by applying a compensation method, wherein the compensation method utilizes a location and a relative angle of elevation between the UE and the NTN node.

### BRIEF DESCRIPTION

Reference is now made to the following descriptions taken in conjunction with the accompanying drawings, in which:

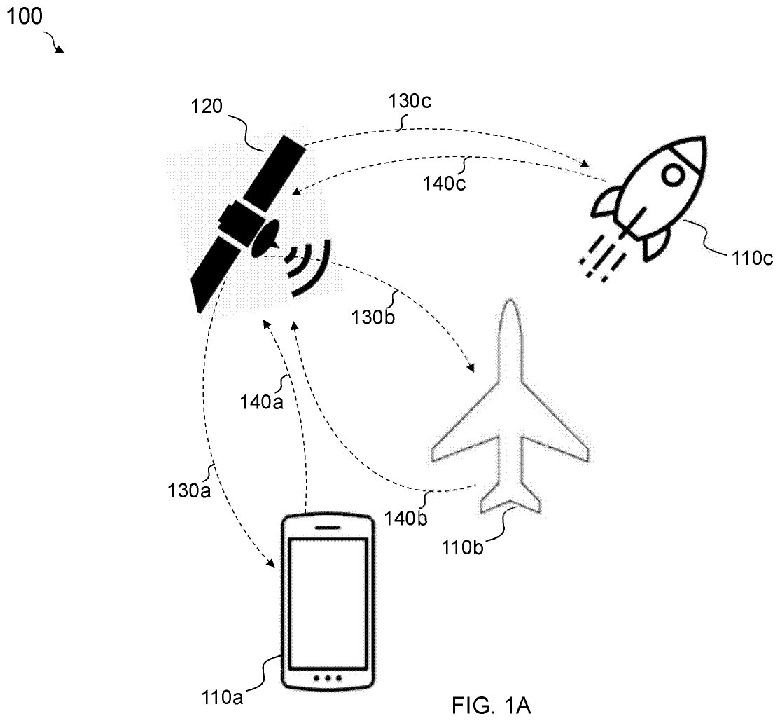

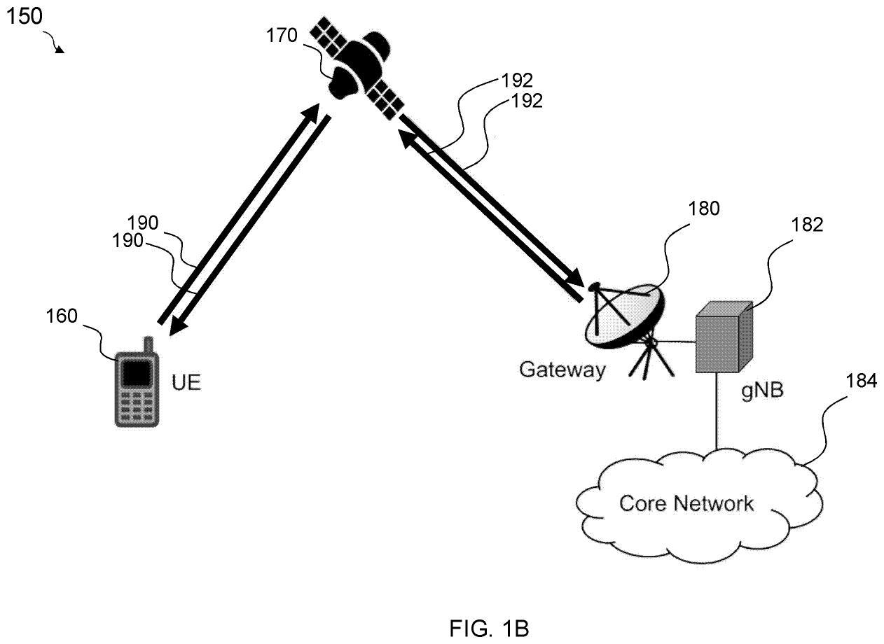

FIG. 1A is an illustration of a diagram of an example communication scenario with a non-terrestrial network (NTN) node and multiple user equipment (UEs);

FIG. 1B is an illustration of a diagram of an example communication scenario with an NTN node and ground-based gateway;

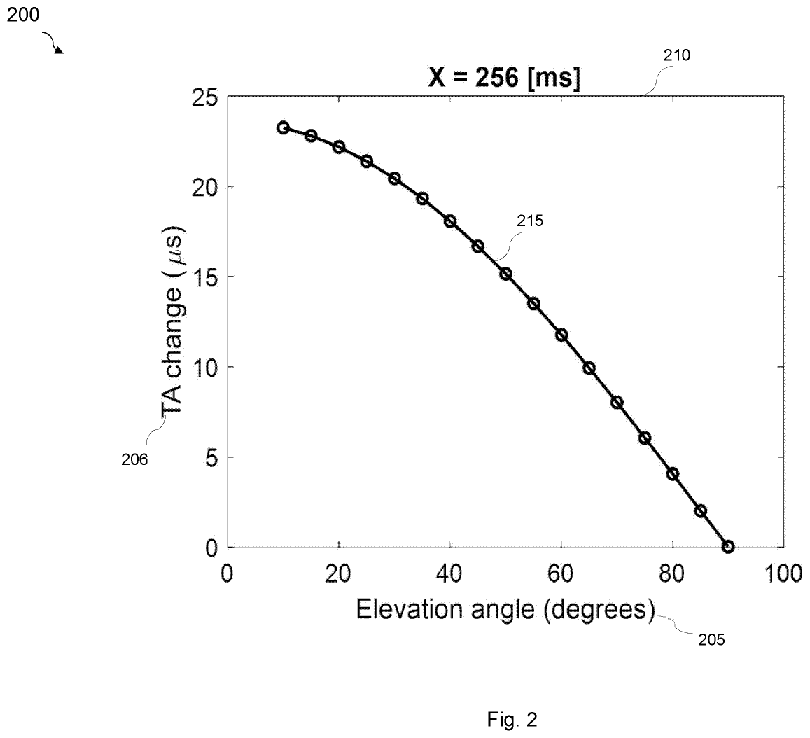

FIG. 2 is an illustration of a diagram of an example chart of a timing advance (TA) drift rate;

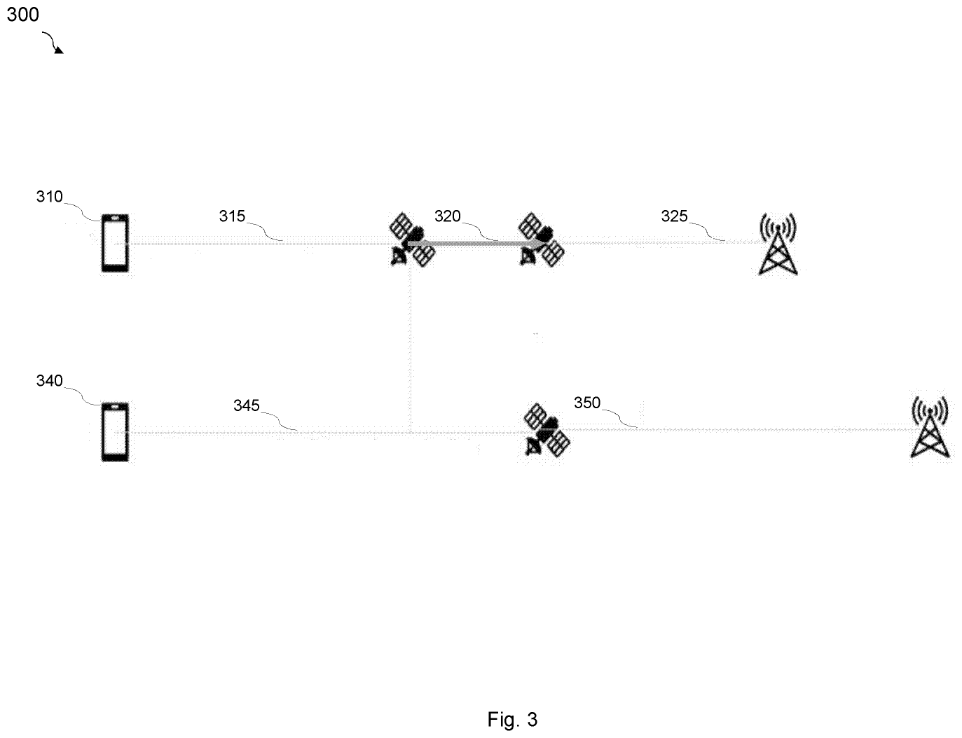

FIG. 3 is an illustration of a diagram of an example TA signal propagation change;

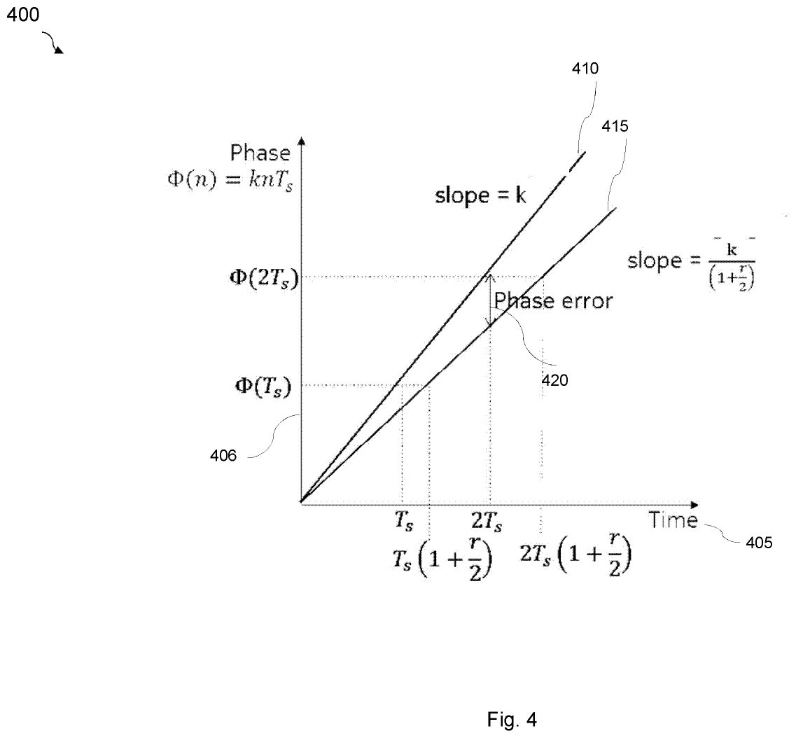

FIG. 4 is an illustration of a diagram of an example chart of a TA drift phase error;

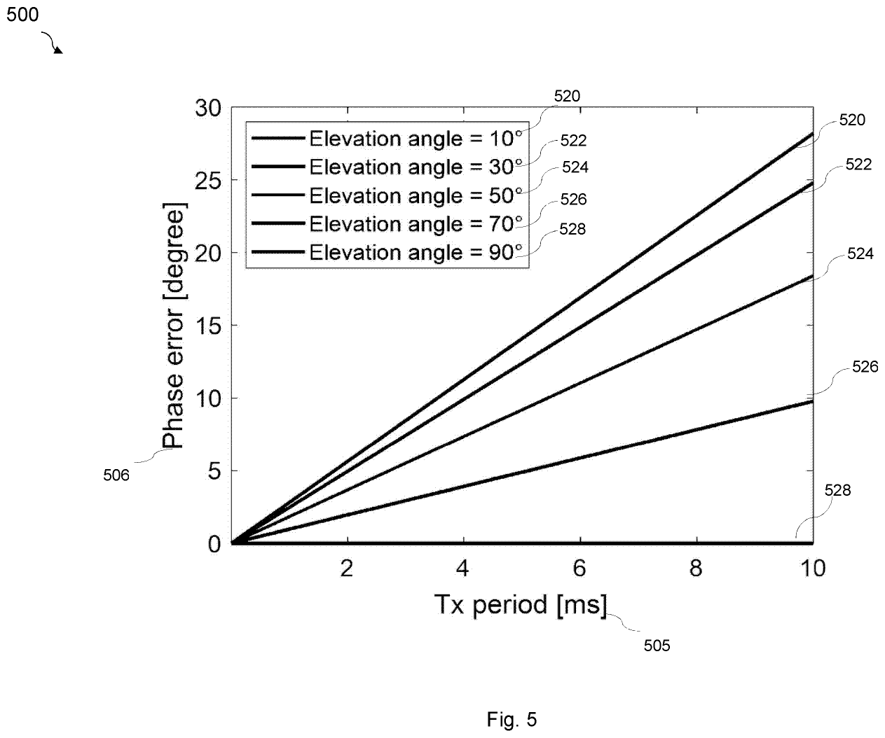

FIG. 5 is an illustration of a diagram of an example chart of an accumulation of phase error over time;

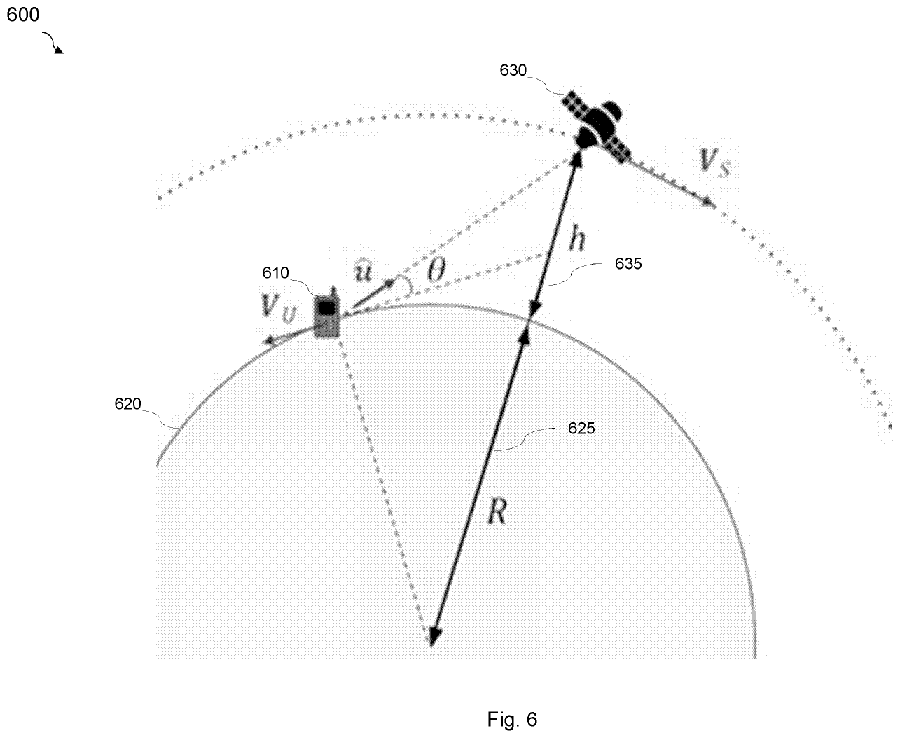

FIG. 6 is an illustration of a diagram of an example TA drift rate compensation model;

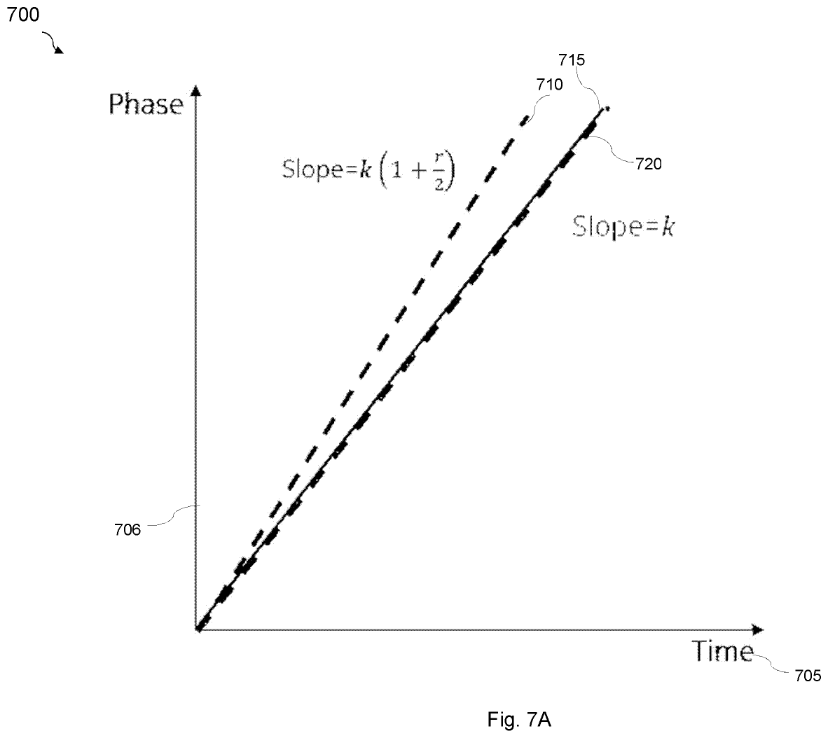

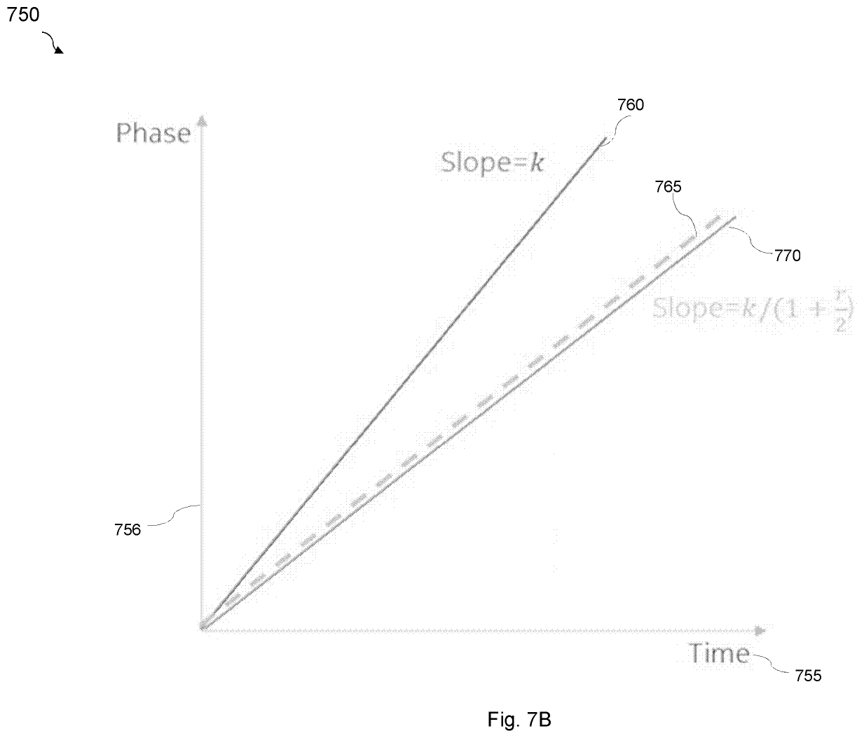

FIG. 7A is an illustration of a diagram of an example chart of a pre-compensation phase error correction applied to a communication signal;

FIG. 7B is an illustration of a diagram of an example chart of a reference phase error correction applied at demodulation;

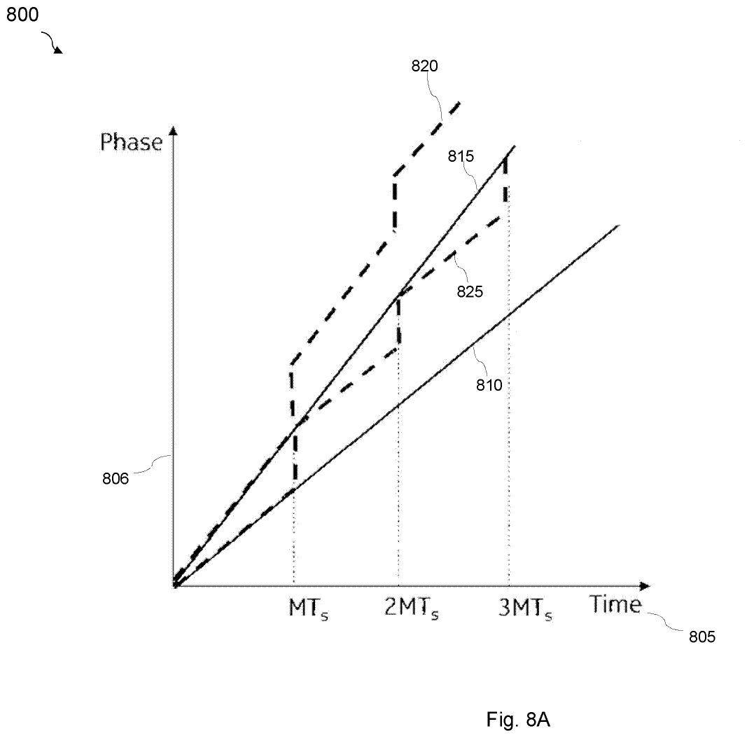

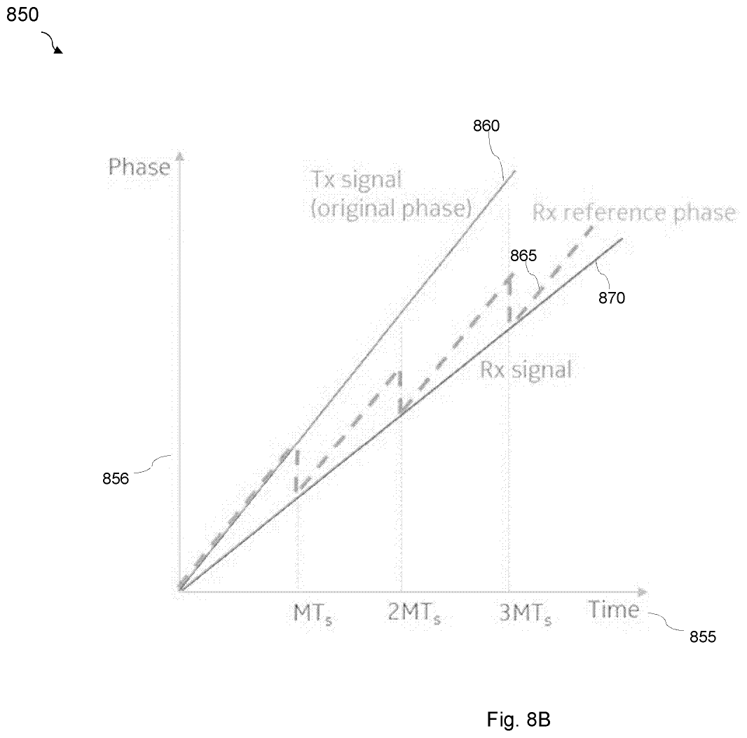

FIG. 8A is an illustration of a diagram of an example chart of a symbol group pre-compensation for phase errors;

FIG. 8B is an illustration of a diagram of an example chart of a symbol group with a reference phase modification for phase errors;

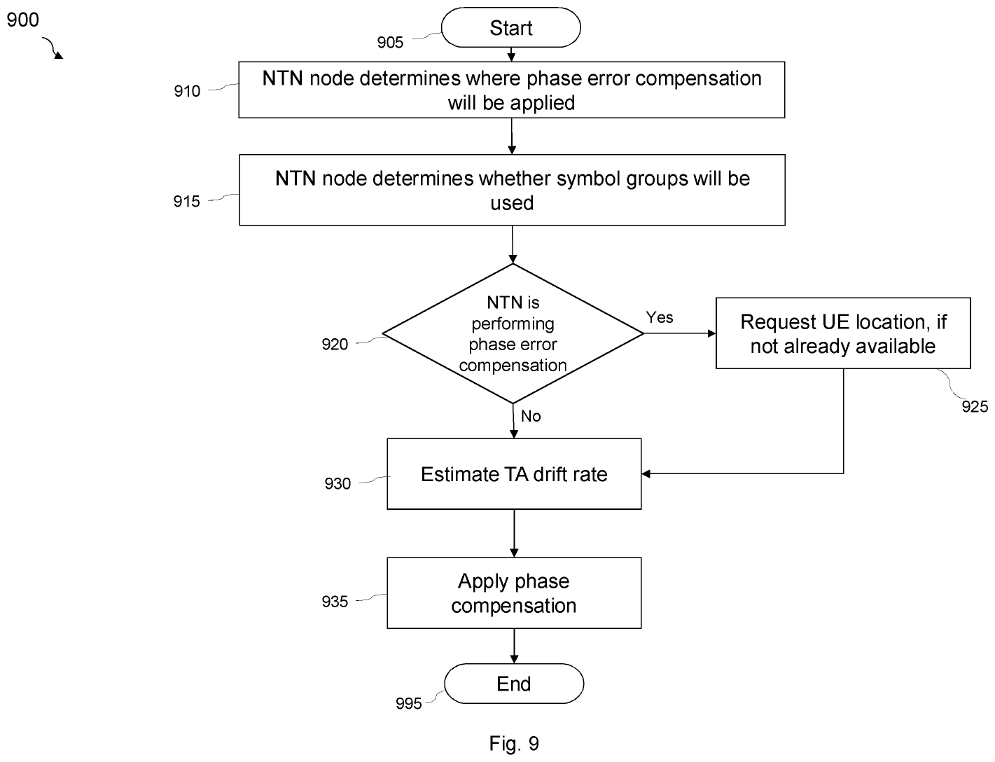

FIG. 9 is an illustration of a flow diagram of an example method to compensate for phase errors in a communication signal;

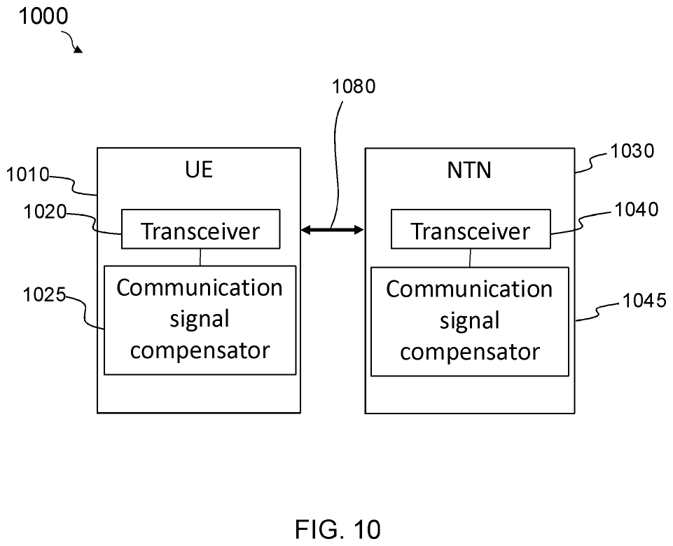

FIG. 10 is an illustration of a block diagram of an example communication system with phase error compensation; and

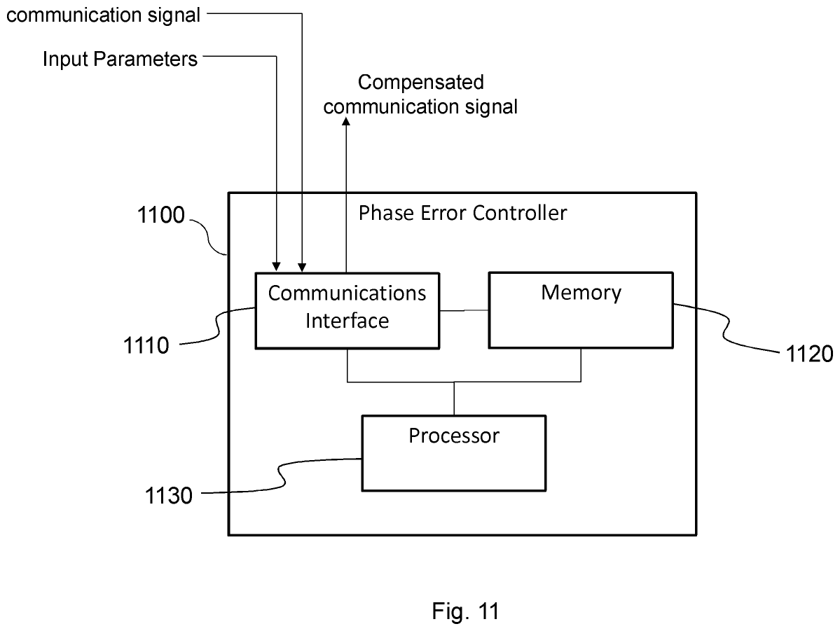

FIG. 11 is an illustration of a block diagram of an example of a phase error controller according to the principles of the disclosure.

### DETAILED DESCRIPTION

In the 5G third-generation partnership project (3GPP) Release 17 proposed standard, there is a study item listed as 8.15.2 for the 3GPP RANI 106-e agenda (time/frequency synchronization) for a sub-project “WP4 IoT over NTN”. The accepted solutions for this study item can be reflected in various 3GPP specifications, for example, TS 36.321, TS 36.331, TS 36.223, and TS 38.211 (wherein these 3GPP specifications are incorporated herein).

In a communication network, a user equipment (UE) can establish a communication connection with a network device. UEs, such as mobile phones, tablets, laptops, vehicles, ships, trains, satellites, balloons, airplanes, space vehicles, and other 5G devices whether movable, mobile, or stationary, can establish a communication link with one or more network devices, i.e., non-terrestrial network (NTN) nodes. The NTN node can implement a communication node, such as a radio access network (RAN) such as a 5G base station (gNB), an evolved universal mobile telecommunications system (UMTS), a terrestrial radio access (E-UTRA), an enhanced 4G eNodeB E-UTRA base station (eNB), e.g., an enhanced Node B, an enhanced gNB (en-gNB), or a next generation eNB (ng-eNB). The NTN node can be implemented using various terrestrial or non-terrestrial systems, such as, ground-based systems, balloons, airplanes, satellites, spaceships, and other non-terrestrial based systems. NTN nodes can be, for example, a low earth orbit (LEO) satellite, a medium earth orbit (MEO) satellite, a geosynchronous earth orbit (GEO) satellite, a high altitude platform station (HAPS), an unmanned aerial vehicle (UAV), an unmanned aircraft system (UAS), or other types of platforms or vehicles. The UE can be capable to transceive, e.g., transmit and receive, communications with one or more nodes of the NTN, for example, see FIG. 1A.

Uplink (UL) transmissions for internet of things (IoT) and machine-to-machine communications such as narrowband IoT (NB-IoT) can use single-carrier frequency division multiple access (SC-FDMA). The SC-FDMA baseband signal can be generated according to Section 10.1.5 of TS36.211. When a resource unit contains only one subcarrier (N_{SC}^{RU}=1), the time-continuous signal S_{k,l}(t) for sub-carrier index k in SC-FDMA symbol l in an uplink slot can be defined as shown in Equation 1.

$$\begin{matrix}Example time - continuous signal for SC - FDMA & \\ & \end{matrix}$$

$${S}_{k , l} ( t ) = {a}_{{k}^{-} , l} \cdot {e}^{j {∅}_{k , j}} \cdot {e}^{j 2 π ( k + \frac{1}{2} ) Δ f ( t - {N}_{CP , l} {T}_{s} )} \qquad Equation 1$$

$${k}^{-} = k + ⌊ \frac{{N}_{SC}^{UL}}{2} ⌋$$

where the phase Ø_{k,j} can be decided using the equations shown in Equation 2. The phase of the current symbol φ(l̅) can be an increment of 2πΔf(k+½)(N+N_{CP,l})Tₛ from the phase of the previous symbol φ(l̅−1).

$$Example phase determination calculations \qquad Equation 2$$

$${∅}_{k , j} = ρ ( \tilde{l} mod 2 ) + {φ}_{k} ( \tilde{l} )$$

$$ρ = \frac{π}{2} ,$$

$$for binary phase shit keying ( BPSK )$$

$$and \frac{π}{4} ,$$

$$for quadrature phase shit keying ( QPSK )$$

$${φ}_{k} ( \tilde{l} ) = 0$$

$$when$$

$$\tilde{l} = 0$$

$$and$$

$${φ}_{k} ( \tilde{l} - 1 ) + 2 π Δ f ( k + \frac{1}{2} ) ( N + {N}_{CP , l} ) {T}_{s} ,$$

$$when$$

$$\tilde{l} > 0$$

$$\tilde{l} = 0 , 1 , … , {N}_{TB} {M}_{rep}^{NPUSCH} {N}_{RU} {N}_{slots}^{UL} {N}_{symb}^{UL} - 1$$

$$l = \tilde{l} mod {N}_{symb}^{UL}$$

A timing advance (TA) for a UE in a NTN can have a rapid drift rate due the fast orbit motion of a satellite or other air or space device, where the satellite can be an NTN node. Therefore, the TA acquired by the UE can quickly become outdated if the transmission time period is long. FIG. 2 demonstrates the amount of the TA value change during an example transmission period, such as a transmission period of 256 milliseconds (ms). The amount of TA value change affects the phase shift in a transmission of SC-FDMA.

In NTN, the required TA can be time-varying due to the motion of a satellite as demonstrated in FIG. 3. During a transmission period, the TA change amount can be approximately the product of the TA drift rate and the transmission time. For IoT devices that rely on a large number of repetitions in data transmission, the long transmission time can incur a non-negligible timing drift for the UL signal. When the signal's propagation distance changes with the movement of a satellite, a phase error can be encountered at the receiver. The transmitted signal can arrive at the receiver with an additional delay, e.g., timing drift. As the received signal is sampled, the receiver can observe the phase of a delayed signal waveform, resulting in a phase error on the received signal.

As the TA change becomes larger, there can be impact on the signal's phase continuity, causing the data symbols to be unable to be demodulated successfully. In particular, a TA change of |ΔTA| can correspond to a timing drift of

$$\frac{\vert Δ TA \vert}{2}$$

for the UL signal waveform.

The timing-drift-induced phase error can exceed the maximum tolerance for demodulation. In SC-FDMA, the sequence of bits transmitted can be mapped to a complex constellation of symbols. For example, if the phase discontinuity of QPSK signals is greater than 45 degrees, the receiver can no longer demodulate the QPSK symbol correctly. If no measure is taken, the SC-FDMA waveform can have an accumulated phase error exceeding the demodulation tolerance well before the transmission is complete. In R1-2105183 (3GPP TSG RAN WG1 #105-e, Sony), the problem of timing misalignment on phase discontinuity is discussed. It proposed to correct the phase error every 8 subframes in a UL transmission. No details were provided as to how to correct the phase error.

This disclosure introduces methods to autonomously compensate for the phase error by using the information on the UE's elevation angle relative to the NTN node. To compensate or correct the phase error of the SC-FDMA symbols, the UE or NTN node first estimates the TA drift rate since it is the TA drift that can cause the phase error. The TA in NTN includes the service link TA (i.e., the round-trip propagation time between the NTN node and the UE) and the feeder link TA (i.e., the round-trip propagation time between the NTN node and the gateway). The TA drift rate r is the sum of the service link TA drift rate r_{SL} and the feeder link drift rate r_{FL}, such as using r=T_{SL}+T_{FL}.

In some embodiments, the UE can estimate the service link drift rate, e.g., TA drift rate, based on the satellite ephemeris (when the NTN node is a satellite) and its own location from the global navigation satellite system (GNSS). The service link drift rate r_{SL} can be calculated from this information, such as by

$${r}_{SL} = \frac{2 ( {V}_{S} - {V}_{U} ) \cdot û}{c} ,$$

where c is the velocity of light, and V_{S} and V_{U} are respectively the velocity of the satellite and of the UE, while û is the unit vector in the direction from the UE to the satellite. In some embodiments, the UE velocity can be ignored since the satellite velocity is far greater than the UE velocity, |V_{S}|>>|V_{U}|. A UE velocity threshold can be applied to the UE velocity to determine when the UE velocity can be ignored for the calculations, for example, a UE velocity threshold can be 3 km/hour, or other values. In some embodiments, the NTN node can calculate the drift rate if it knows or can request the UE's location information. The feeder link TA information can be broadcast in the SIB. The UE can estimate the feeder link drift rate based on the information provided by the SIB.

In some embodiments, the UE can compensate for the timing drift induced phase error in its modulation process utilizing an estimated TA drift rate. A timing correction factor χ can be included with the increment of the SC-FDMA symbol phase. Specifically, the I-th symbol phase in the data transmission on the k-th subcarrier can be represented by Equation 3, e.g., the phase error can be pre-compensated by scaling up the phase difference across symbols by a factor χ.

$$Example timing correction factor$$

$$φ ( \tilde{l} ) = φ ( \tilde{l} - 1 ) + 2 π Δ f ( k + \frac{1}{2} ) ( N + {N}_{CP , l} ) {T}_{s} χ \qquad Equation 3$$

where χ is a function of the TA drift rate r, such that χ(r)=1+r/2. With the phase pre-compensation, the phase of the \hat{l}-th symbol of the received signal will be φ(l̅)=φ(l̅−1)+2πΔf(k+½)(N+N_{CP,l})Tₛ, after propagation while the TA drifts. This phase is the same as the original phase for demodulation reference. No degradation due to phase errors will be experienced by the receiver. The satellite motion induced phase error can be reduced or eliminated by the phase pre-compensation at the transmitter.

The TA drift rate can be the sum of the service link TA drift rate and the feeder link TA drift rate. The UE can estimate the TA drift rate from the satellite (or other device platform) ephemeris and feeder link TA in the system information block (SIB), and its own location. Note that the pre-compensated time (r/2)(N+N_{CP,l})Tₛ is the drifted time in a symbol duration. When the TA is fixed, r=0, and the correction factor χ=1, the equation can produce the symbol phase the same as the current standard.

In some embodiments, when the UE's location is known to the network, the NTN node can estimate the TA drift for the UE. The phase error can be corrected by the NTN node rather than the UE pre-compensating the phase error. In the demodulation process, the NTN node can use the time drifted symbol phase for the \hat{l}-th symbol as described in the above embodiment, using a timing correction factor of χ(r)=(1+r/2)⁻¹≈1−r/2, where r is the estimated TA drift rate and the approximation can be made given that the TA drift rate value is very small, e.g., |r|<<1. In some embodiments, the NTN node can request the UE send the UE's location information, such as when the NTN node does not have the UE location data. In some embodiments, the NTN node can receive the UE location information, from the UE or from other signaling or input parameters.

In some embodiments, the phase error pre-compensation or correction can be performed in groups of multiple SC-FDMA symbols. The phase error compensation can be an accumulated phase error compensation. For example, if a group consists of M consecutive symbols, the phase increment to be pre-compensated or corrected for one group can be represented by Equation 4.

$$Example phase increment for correction \qquad Equation 4$$

$$Δφ = 2 πΔ f ( k + 1 / 2 ) ( N + {N}_{CP , l} ) {T}_{s} ( Mr / 2 )$$

The group index for the \tilde{l}-th symbol of data transmission can be

$$⌊ \frac{( \tilde{l} + 1 )}{M} ⌋ .$$

The l̅-th symbol phase can be demonstrated using Equation 5.

$$Example \tilde{l} - th symbol phase \qquad Equation 5$$

$$\tilde{φ} {(}^{\sim} ) = \tilde{φ} ( \tilde{l} - 1 ) + 2 π Δ f ( k + 1 / 2 ) ( N + {N}_{CP , l} ) {T}_{s}$$

$$φ ( \tilde{l} ) = \tilde{φ} ( \tilde{l} ) \pm ⌊ \frac{( \tilde{l} + 1 )}{M} ⌋ Δφ$$

where the “+” in the second equation is used when the phase error is pre-compensated by the UE (e.g., the transmitter) and the “−” is used when the phase error is corrected by the NTN node (e.g., the receiver). The compensation for the TA drift can be implemented in the transmitter or receiver, not in combination.

In some embodiments, the phase error can be corrected in a longer time unit than a symbol duration. The compensation can correct a total phase error accumulated (e.g., an accumulated phase error compensation) over a phase time period, e.g., a group of SC-FDMA symbols. Groups of SC-FDMA symbols can have different numbers of symbols. For example, a group can have one slot, several N symbols, or N slots (e.g., a slot set with continuous slots). The amount of phase that needs to be added to compensate for the error during transmission time of a group can be represented by Equation 6.

$$Example group phase compensation at the UE \qquad Equation 6$$

$$Δφ = 2 πΔ f ( k + \frac{1}{2} ) ( N + {N}_{CP , l} ) {T}_{s} ( \frac{Mr}{2} )$$

If the phase error is to be compensated at the NTN node in the same group size, the phase compensation per group can be represented by Equation 7:

$$Example group phase compensation at the NTN node \qquad Equation 7$$

$$2 πΔ f ( k + \frac{1}{2} ) ( N + {N}_{CP , l} ) {T}_{s} M [ \frac{1}{1 + \frac{r}{2}} - 1 ]$$

The TA drift rate in NTN is a very small number. For example, LEO satellites at 600 km altitude have the TA drift rates such that |r|<9×10⁻⁵, i.e., the drift rate threshold is very small. When the drift rate threshold is very small, an approximation can be used, such as (1+r/2)⁻¹≈1−r/2. Equation 7 can be simplified to

$$2 π Δ f ( k + \frac{1}{2} ) ( N + {N}_{CP , l} ) {T}_{s} ( - \frac{Mr}{2} ) = - Δφ .$$

The phase compensation or correction amount for a group of M symbols is Δφ if the compensation is applied at the UE and −Δφ if the correction is applied at the gNB. This correction term ±Δφ must increment with the symbol group. For example, for the i-th group, i∈{0, 1, 2, . . . }, the phase correction can be (i−1)(±Δφ). The l̅-th symbol, l̅∈{0, 1, 2, . . . }, belongs to a group of index [(l̅+1)/M] and will need a phase correction of

$$\pm ⌊ \frac{\tilde{l} + 1}{M} ⌋ Δφ ,$$

where └⋅┘ is the floor function.

The original symbol phase for the \hat{l}-th SC-FDMA symbol in \tilde{φ}(\tilde{l})=(\tilde{l}−1)+2πΔf(k+½) (N+N_{CP,l})Tₛ can be added to a group-wise phase correction as shown by φ(\tilde{l})=

$$\tilde{φ} ( \tilde{l} ) \pm ⌊ \frac{( \tilde{l} + 1 )}{M} ⌋ Δφ$$

to mitigate the phase error. The sign of the correction term depends on whether the correction is applied at the UE (using the “+”) or the NTN node (using the “−”).

An example, for demonstration purposes, of the messaging changes to the 3GPP standard are shown in Table 1. Other messaging changes and different messaging changes can be utilized to implement this disclosure; Table 1 is for example.

TABLE 1
Example messaging to support alternative signaling
scheme for a scheduling information

| Message | Change |
|---|---|
| Message: Random access | UE sends its location to the NTN node. |
| message 3, RRCSetupRequest, | The elevation is information is optional. |
| or RRCReestablishmentRequest | |
| Message: RRCSetup or | NTN node indicates whether it will |
| RRCReconfiguration | compensate for the phase error in the |
| | transmission or if the UE should |
| | compensate. |

Turning now to the figures, FIG. 1A is an illustration of a diagram of an example communication scenario 100 with a NTN node and multiple UEs. Communication scenario 100 is a demonstration of one type of environment for this disclosure. The environment for communication scenario 100 includes a UE 110a, a UE 110b, a UE 110c (collectively, UEs 110), and an NTN node 120. There can be fewer or additional UEs in UEs 110. NTN node 120 can be various types of communication nodes, such as a gNB, and be implemented on one of various types of vehicles, such as a balloon, an airplane, a glider, a satellite, or other vehicle types. In other embodiments, NTN node 120 can be a ground based node and UEs 110 can be a vehicle, satellite, or other movable object.

An example set of downlink (DL) and UL signals are shown in communication scenario 100. DL signal 130a, DL signal 130b, DL signal 130c, (collectively DLs 130), UL signal 140a, UL signal 140b, and UL signal 140c (collectively UIs 140) can experience phase errors across a communication time interval due to the relative velocity differences between NTN node 120 and the UEs 110. UEs 110 can be utilized to provide the location information for the respective UE, including the relative elevation, if available. The location information can be used to improve the estimate of the TA drift rate.

FIG. 1B is an illustration of a diagram of an example communication scenario 150 with an NTN node and ground-based gateway. Communication scenario 150 is a demonstration of one type of environment for this disclosure, such as a transparent architecture, where the satellite NTN node is a repeater. Communication scenario 150 has a UE 160 located on or near the surface, and can be stationary or moving, such as on a vehicle. An NTN node 170 can be satellite. NTN node 170 and UE 160 have a communication link shown as service links 190.

A gateway 180 can be located on or near the surface and can be stationary or moving, such as on a ship or truck. Gateway 180 is linked to a gNB 182 which in turn is linked to a core network 184. NTN node 170 and gateway 180 have a communication link shown as feeder links 192. As NTN node 170 moves through space, such as in its orbital path, the distance a communication signal travels for service links 190 and feeder links 192 can change, thereby altering the phase of the communication signal. This altering of the phase of the communication signal can be compensated for to improve the reliability of the demodulation process. In some embodiments, such as in a regenerative architecture, gNB 182 can be implemented with NTN node 170. In this embodiment, the feeder link TA is assumed to be zero.

FIG. 2 is an illustration of a diagram of an example chart 200 of a TA drift rate. Chart 200 demonstrates the amount of the TA value change during a transmission period of X=256 ms at different elevation angles from 10 to 90 degrees when the UE is connected with a LEO satellite of 600 kilometers (km) of altitude. The TA value change, ΔTA, is defined as the difference between the initial TA value at the given elevation angle and new TA value after a transmission time period, such as shown by |ΔTA|=|TAᵢₙᵢₜᵢₐₗ−TAₗₐₜₑᵣ|. The amount of TA value change affects the phase shift in communication signal transmission of SC-FDMA.

Chart 200 has an x-axis 205 showing the elevation angle in degrees between the UE and the NTN node. A y-axis 206 is showing the estimated TA change in microseconds (μs). A plot area 210 shows the plotted data of the elevation angle to the TA change. A line 215 is the plotted data showing that as a device, such as the UE, approaches a lower angle, the TA change increases, meaning that the TA drift rate is higher resulting in an increased phase error.

FIG. 3 is an illustration of a diagram of an example TA signal propagation change 300. In NTN, the required TA can be time-varying due to the motion of the satellite. During a transmission period, the TA change amount is approximately the product of the TA drift rate and the transmission time. For IoT devices that rely on a large number of repetitions in data transmission, the long transmission time can incur a non-negligible timing drift for the UL signal.

TA signal propagation change 300 shows a UE 310 at a time of t=0. A line segment 315 shows the initial propagation distance for a service link between the UE 310 and an NTN node, such as a satellite. From the satellite to a ground based node, a feeder link 325 is shown. During the transmission of a communication signal, the satellite can move, as shown by a line segment 320. A UE 340 is UE 310 at a subsequent time, such as t=T. The service link distance has increased at time T as shown by a line 345. With the satellite in a new location, a feeder link 350 is now shorter than feeder link 325. The satellite motion can cause a change in signal propagation time and signal propagation distance. These changes in the service link and feeder link can cause phase errors in the received communication signals for which compensation is needed to improve reliability of the demodulation of the communication signals.

FIG. 4 is an illustration of a diagram of an example chart 400 of a TA drift phase error. When the propagation distance of the communication signal changes with the movement of a satellite, a phase error can be encountered at the receiver. The phase of the transmitted signal is Φ(Tₛ) at a time of Tₛ. The transmitted signal arrives at the receiver with an additional delay known as timing drift. As the received signal is sampled at Tₛ, the receiver observes the phase of a delayed signal waveform, resulting in a phase error on the received signal. The symbol phase of the received signal increases at a lower rate k/(1+r/2) as opposed to the original rate k, where k represents the slope of the line as the phase changes.

Chart 400 has an x-axis 405 showing an increase of the time interval for the communication signal. A y-axis 406 shows the relative phase change of the communication signal. A transmit signal line 410 shows the original communication signal, with a slope of k. A receiving signal line 415 shows the same communication signal at the reception point, and in this example, has a slope of

$$\frac{k}{( 1 + \frac{r}{2} )} .$$

A double header arrow 420 shows the potential phase error experienced by the receiver of the communication signal. This phase error should be compensated for to improve the demodulation of the communication signal.

FIG. 5 is an illustration of a diagram of an example chart 500 for an accumulation of a phase error over time. As the TA change becomes large, there can be an impact on the signal's phase continuity, causing the data symbols to not to be demodulated successfully. A TA change of |ΔTA| corresponds to a timing drift of

$$\frac{\vert Δ TA \vert}{2}$$

for the signal waveform. Chart 500 demonstrates the accumulated timing drift in the communication signal during the transmission period. This timing drift can produce an increasing phase error. The phase error can increase as the elevation angle decreases, due to the TA drift rate being higher at the lower elevation angles.

Chart 500 has an x-axis 505 showing the increase in time in milliseconds over the communication signal transmission time interval. A y-axis 506 shows the phase error in degrees. A line 520 demonstrates the phase error increase for a communication signal from a UE at a relative 10° elevation angle to a satellite NTN node. A line 522 demonstrates the phase error increase for a communication signal from a UE at a relative 30° elevation angle to a satellite NTN node. A line 524 demonstrates the phase error increase for a communication signal from a UE at a relative 50° elevation angle to a satellite NTN node. A line 526 demonstrates the phase error increase for a communication signal from a UE at a relative 70° elevation angle to a satellite NTN node. A line 528 demonstrates the phase error increase for a communication signal from a UE at a relative 90° elevation angle to a satellite NTN node (there is negligible phase error).

FIG. 6 is an illustration of a diagram of an example TA drift rate compensation model 600. A TA drift rate can be calculated using the elevation angle, θ, and other information. Model 600 is one example of an NTN communication system. Other NTN systems can be utilized as well, such as where the UE is in the air or in space, or when the NTN node is ground based or in the air.

Model 600 has a UE 610 located at the surface of the Earth 620, with a radius 625. In orbit around Earth 620 is a satellite 630, which is an NTN node. Satellite 630 is at an orbital height 635. UE 610 is moving at a velocity shown by V_{U}. Satellite 630 is moving at a velocity shown by V_{S}. These parameters can be utilized to estimate the TA drift rate which in turn can be used to modify the communication signal to compensate for the incurred phase errors.

FIG. 7A is an illustration of a diagram of an example chart 700 demonstrating a pre-compensation phase error correction applied to a transmission signal. As one node of the communication system moves significantly over the communication signal's time interval, phase errors can occur. Chart 700 has an x-axis 705 showing time increasing over the communication signal's time interval. A y-axis 706 shows the phase of the communication signal.

A line 710 shows a phase pre-compensated communication signal transmitted by the transmitter over time with a slope of k(1+r/2). A solid line 715 shows the ideal communication signal that is expected at the receiver. A dashed line 720 shows the phase pre-compensated communication signal received by the receiver over time, with a slope of k. Dashed line 720 closely matches the solid line 715 which shows that the phase errors have been minimized by the compensation methods disclosed herein.

FIG. 7B is an illustration of a diagram of an example chart 750 of a reference phase error correction applied at demodulation. As one node of the communication system moves significantly over the communication signal's time interval, phase errors can occur. The NTN node can modify the reference phase for demodulation to match the received symbol phase. Chart 750 has an x-axis 755 showing time increasing over the communication signal's time interval. A y-axis 756 shows the phase of the communication signal.

A line 760 shows a communication signal without compensation over time with a slope of k. A dashed line 765 shows the reference phase for demodulation after phase compensation is applied at the NTN node. A solid line 770 shows the received signal at the NTN node, and has a slope of

$$\frac{k}{( 1 + \frac{r}{2} )} .$$

Solid line 770 closely matches the reference line of shown by dashed line 765 which shows that the phase errors have been minimized by the compensation methods disclosed herein.

FIG. 8A is an illustration of a diagram of an example chart 800 of a symbol group pre-compensation for phase errors. Chart 800 demonstrates the effect of symbol group phase pre-compensation by the UE. The phase error over the symbol group time interval can be compensated for as a unit of the group. The size of the group can be changed using input parameters. For example, if a group is too large, the accumulated phase error may be too great to be compensated for by an average phase compensation. In another example, the group may be too small which could increase the processing demands of each respective device to handle the number of groups.

Chart 800 has an x-axis 805 showing the increase of time of the time interval for the communication signal. A y-axis 806 is the phase of the communication signal. A line 810 shows the ideal received communication signal (e.g., this would have a slope of k). A line 815 shows the original transmission communication signal drifting to a different phase than line 810. A dashed line 820 shows the transmitted transmission communication signal modified at a symbol group level (hence the step nature of dashed line 820). The modification is to compensate for phase errors due to TA drift. A dashed line 825 shows the received communication signal. Dashed line 825 is closer in slope to line 815 representing the ideal communication signal line 815. Dashed line 825 shows the phase errors have been reduced from the original communication signal (line 815) and that some phase errors remain in the communication signal.

The group size of M symbols can be a pre-determined number or a network configurable variable. Residual phase errors can exist within the symbol group after pre-compensation or correction. The larger the group (M), the larger the accumulated error differential. The phase error tolerance would need to be considered in deciding on the group size. In addition, the amount of phase correction can be proportional to M. A large phase increase at the boundary of a group can increase the peak-to-average power ratio (PAPR) of the waveform and can impact the maximum transmit power allowed by the UE power amplifier.

FIG. 8B is an illustration of a diagram of an example chart 850 of a symbol group with a reference phase modification for phase errors. Chart 850 demonstrates the effect of symbol group reference phase correction by the NTN node. The phase error over the symbol group time interval can be compensated for as a unit of the group. The size of the group can be changed using input parameters. For example, if a group is too large, the accumulated phase error may be too great to be compensated for by an average phase compensation. In another example, the group may be too small which could increase the processing demands of each respective device to handle the number of groups.

Chart 850 has an x-axis 855 showing the increase of time of the time interval for the communication signal. A y-axis 856 is the phase of the communication signal. A line 860 shows the original communication signal (e.g., this would have a slope of k). A line 865 shows a reference signal that has been phase corrected at a group symbol level. The step nature of line 865 shows the phase correction factor averaged for a group of symbols. A line 870 shows the actual phase of the received signal. Line 865 is close to line 870 showing that some phase errors can continue to exist, while the overall phase error is minimized.

FIG. 9 is an illustration of a flow diagram of an example method 900 to compensate for phase errors in a transmission. Method 900 can be performed by a UE, an NTN node, or partially by a UE and partially by an NTN node. In some example embodiments, input parameters can be received by the UE from the NTN node. Method 900 can be performed, for example, wholly or in part, by communication scenario 100 of FIG. 1A, by communication scenario 150 of FIG. 1B, by communication system 1000 of FIG. 10, or by phase error controller 1100 of FIG. 11.

Method 900 begins at a step 905 and proceeds to a step 910. In step 910, the NTN node can determine where the phase compensation is to be applied. It can be applied at a transmission time as a pre-compensation process, or at a receive time as a correction process. In a step 915, the NTN node can determine whether symbol groups will be used and how large the symbol groups will be. If symbol groups are not used, symbols are compensated on a symbol-by-symbol basis.

In a decision step 920, if the NTN node is performing the phase error compensation, then method 900 proceeds to a step 925. If the NTN node is not performing the phase error compensation, then method 900 proceeds to a step 930. In step 925, if the NTN node does not have the location of the UE, or if the location information is out of date, then the NTN node can receive the location of the UE. Optionally, the location can include the relative angle of elevation information between the UE and the NTN node. The NTN node can request the location information from the UE, or the NTN node receive the location information through other signaling or input data. Method 900 proceeds to step 930.

In step 930, the TA drift rate can be estimated using the location information, such as the UE location information, satellite ephemeris information, and other input parameters. In a step 935, when the UE is performing the modification of the communication signal, the estimated TA drift rate can be applied to a communication signal to compensate for TA drift causing phase errors, e.g., utilizing a pre-compensation transformation of the communication signal. When the NTN node is performing the modification of the communication signal, the estimated drift rate can be applied to a communication signal, e.g., utilizing a modification of the expected signal (e.g., expected phase or reference phase) for reception (demodulation process). For example, when an NTN node compensates for the phase error, the reference signal can be modified so that the reference signal of the demodulator at the NTN node is matched to the received, drifted communication signal. Method 900 proceeds to a step 995. In step 995 the method ends.

FIG. 10 is an illustration of a block diagram of an example communication system 1000 with phase error compensation. Communication system 1000 is an example system and could have additional communication nodes and additional UEs. Communication system 1000 can implement the disclosed solutions, such as method 900 of FIG. 9 and implement the phase error controller 1100 of FIG. 11. Communication system 1000 has a UE 1010 and an NTN node 1030.

UE 1010 has a transceiver 1020 capable of receiving communication signals and transmitting communication signals with NTN node 1030 using a signal connection 1080, for example, receiving input parameters from NTN node 1030 (for example, a size of a symbol group or notice that the NTN node will be performing the phase error compensation), or sending a communication signal. UE 1010 has a UE communication signal compensator 1025, which can determine how UE 1010 utilizes the received input parameters and compensates communication signals, for example, utilizing the schemes described in method 900 of FIG. 9, or elsewhere herein.

NTN node 1030 has a transceiver 1040 capable of receiving communication signals and transmitting communication signals with UE 1010 using signal connection 1080. NTN node 1030 has a communication signal compensator 1045 that is capable of analyzing the received UE communication signal, such as applying a correction, and is capable of pre-compensating a transmitted communication signal. Communication signal compensator 1045 is capable of determining input parameters at UE 1010. NTN node 1030 can communicate the input parameters to UE 1010 using, for example, a system information signal, an RRC signal, a DCI, or other signals.

The elements of UE 1010 and NTN node 1030 are shown as a functional view, where the implementation can be by software, hardware, or a combination thereof. In some aspects, the functions shown can be combined with other functions of the respective UE 1010 or NTN node 1030.

FIG. 11 is an illustration of a block diagram of an example of a phase error controller 1100 according to the principles of the disclosure. Phase error controller 1100 can be stored on a single computer or on multiple computers. The various components of phase error controller 1100 can communicate via wireless or wired conventional connections. A portion or a whole of phase error controller 1100 can be located as part of a UE and other portions of phase error controller 1100 can be located as part of an NTN node communicating with the UE. Phase error controller 1100 can be virtual or partially virtual while hosted on another system or process.

Phase error controller 1100 can be configured to perform the various functions disclosed herein including receiving NTN node input parameters. The various functions performed can be an execution of the methods and processes described herein, such as method 900 of FIG. 9. Phase error controller 1100 can implement communication system 1000 of FIG. 10. Phase error controller 1100 includes a communications interface 1110, a memory 1120, and a processor 1130.

Communications interface 1110 is configured to transmit and receive data. For example, communications interface 1110 can receive the input parameters from an NTN node. Communications interface 1110 can transmit the communication signal, or other legacy signaling. Communications interface 1110 can communicate via communication systems used in the industry. For example, wireless or wired protocols can be used. Communication interface 1110 is capable of performing the operations as described for transceiver 1020 or transceiver 1040 of FIG. 10.

Memory 1120 can be configured to store a series of operating instructions and data, e.g., storing instructions and data, that direct the operation of processor 1130 when initiated, including the code representing the methods for compensating for TA drift in communication signals. Memory 1120 is a non-transitory computer readable medium. Multiple types of memory can be used for data storage and memory 1120 can be distributed.

Processor 1130 can be configured to determine the appropriate method for compensating for phase errors in communication signals utilizing the received input parameters. For example, processor 1130 can determine whether the UE or the NTN node will perform the compensation, and whether the compensation will be done for each symbol or for a group of symbols. Processor 1130 can be configured to direct the operation of the phase error controller 1100. Processor 1130 includes the logic to communicate with communications interface 1110 and memory 1120, and perform the functions described herein to determine the phase error compensation methods. Processor 1130 is capable of performing or directing the operations as described by UE communication signal compensator 1025 or communication signal compensator 1045 of FIG. 10.

A portion of the above-described apparatus, systems or methods may be embodied in or performed by various analog or digital data processors, wherein the processors are programmed or store executable programs of sequences of software instructions to perform one or more of the steps of the methods. A processor may be, for example, a programmable logic device such as a programmable array logic (PAL), a generic array logic (GAL), a field programmable gate arrays (FPGA), or another type of computer processing device (CPD). The software instructions of such programs may represent schemes and be encoded in machine-executable form on non-transitory digital data storage media, e.g., magnetic or optical disks, random-access memory (RAM), magnetic hard disks, flash memories, and/or read-only memory (ROM), to enable various types of digital data processors or computers to perform one, multiple, or all of the steps of one or more of the above-described methods, or functions, systems or apparatuses described herein.

Portions of disclosed examples or embodiments may relate to computer storage products with a non-transitory computer-readable medium that have program code thereon for performing various computer-implemented operations that embody a part of an apparatus, device or carry out the steps of a method set forth herein. Non-transitory used herein refers to all computer-readable media except for transitory, propagating signals. Examples of non-transitory computer-readable media include, but are not limited to: magnetic media such as hard disks, floppy disks, and magnetic tape; optical media such as CD-ROM disks; magneto-optical media such as floppy disks; and hardware devices that are specially configured to store and execute program code, such as ROM and RAM devices. Examples of program code include machine code, such as produced by a compiler, and files containing higher level code that may be executed by the computer using an interpreter.

In interpreting the disclosure, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced.

Those skilled in the art to which this application relates will appreciate that other and further additions, deletions, substitutions, and modifications may be made to the described embodiments. It is also to be understood that the terminology used herein is for the purpose of describing particular embodiments only, and is not intended to be limiting, since the scope of the present disclosure will be limited only by the claims. Unless defined otherwise, all technical and scientific terms used herein have the same meaning as commonly understood by one of ordinary skill in the art to which this disclosure belongs. Although any methods and materials similar or equivalent to those described herein can also be used in the practice or testing of the present disclosure, a limited number of the exemplary methods and materials are described herein.

Each of the aspects as described in the SUMMARY section can have one or more of the following additional elements in combination. Element 1: wherein the UE performs the modify the communication signal. Element 2: modify the communication signal utilizes a pre-compensation transformation of the communication signal. Element 3: wherein the NTN node performs the modify the communication signal. Element 4: modify the communication signal utilizes a modification of a reference phase for a demodulation process. Element 5: request location information from the UE when the modification of an expected phase of the communication signal is applied at the NTN node. Element 6: request location information from the NTN node when the modification of the communication signal is applied at the UE. Element 7: wherein the NTN node is a satellite and the UE utilizes an ephemeris of the satellite and a location of the UE to estimate the TA drift rate. Element 8: wherein a feeder link TA information is broadcast in a SIB and the estimate a TA drift rate utilizes the feeder link TA information. Element 9: wherein the TA drift rate is a sum of a service link TA drift rate and a feeder link TA drift rate. Element 10: wherein the modify the communication signal is applied to a group of SC-FDMA symbols. Element 11: wherein the communication signal is of a longer duration than the group of SC-FDMA symbols and the modify the communication signal applies an accumulated phase error compensation over a duration of the communication signal. Element 12: wherein the group of SC-FDMA symbols is one or more slots, or one or more symbols. Element 13: wherein the TA drift rate is less than a drift rate threshold, and an approximation of the TA drift rate is utilized in the modify the communication signal. Element 14: estimating the TA drift rate of the communication signal prior to the applying. Element 15: wherein the NTN node is a satellite and the estimating the TA drift rate utilizes a satellite ephemeris of the NTN node. Element 16: wherein the applying the phase compensation is performed at the UE. Element 17: applying the phase compensation utilizes a pre-compensation phase error correction with the communication signal. Element 18: wherein the applying the phase compensation is performed at the NTN node. Element 19: applying the phase compensation modifies a reference phase for a demodulation process. Element 20: requesting a location of the UE when the NTN node is applying the phase compensation. Element 21: wherein the communication signal includes a group of SC-FDMA symbols. Element 22: wherein the estimating the TA drift rate utilizes an accumulated phase error compensation over a duration of the communication signal. Element 23: wherein the NTN node receives the location or the relative angle of elevation of the UE. Element 24: wherein the TA drift is estimated using a feeder link TA received in a SIB. Element 25: wherein the NTN node is one of a gNB, an UMTS, an E-UTRA, an eNB, an en-gNB, or a ng-eNB.

1. An apparatus, comprising:
one or more processors; and
memory storing instructions and data that, when executed by the one or more processors, cause the apparatus to:
estimate a timing advance (TA) drift rate; and
modify a communication signal from a user equipment (UE) to a non-terrestrial network (NTN) node to correct for a phase error caused by the TA drift rate.

2. The apparatus as recited in claim 1, wherein the UE performs the modifying of the communication signal, and the modifying of the communication signal utilizes a pre-compensation transformation of the communication signal.

3. The apparatus as recited in claim 1, wherein the NTN node performs the modifying of the communication signal, and the modifying of the communication signal utilizes a modification of a reference phase for a demodulation process.

4. The apparatus as recited in claim 1, wherein the instructions and the data further cause the apparatus to:
request location information from the UE when the modification of an expected phase of the communication signal is applied at the NTN node or from the NTN node when the modification of the communication signal is applied at the UE.

5. The apparatus as recited in claim 1, wherein the NTN node is a satellite and the UE utilizes an ephemeris of the satellite and a location of the UE to estimate the TA drift rate.

6. The apparatus as recited in claim 5, wherein a feeder link TA information is broadcast in a system information block (SIB) and the estimating of the TA drift rate utilizes the feeder link TA information.

7. The apparatus as recited in claim 1, wherein the TA drift rate is a sum of a service link TA drift rate and a feeder link TA drift rate.

8. The apparatus as recited in claim 1, wherein the modifying of the communication signal is applied to a group of single-carrier frequency division multiple access (SC-FDMA) symbols.

9. The apparatus as recited in claim 8, wherein the communication signal is of a longer duration than the group of SC-FDMA symbols and the modifying of the communication signal applies an accumulated phase error compensation over a duration of the communication signal.

10. The apparatus as recited in claim 8, wherein the duration of the group of SC-FDMA symbols is one or more slots.

11. The apparatus as recited in claim 1, wherein the TA drift rate is less than a drift rate threshold, and an approximation of the TA drift rate is utilized in the modifying of the communication signal.

12. A method, comprising:
applying, by a device of a non-terrestrial network (NTN), a phase compensation to a communication signal by utilizing a timing advance (TA) drift rate, wherein the communication signal is between a transmitter and a receiver, wherein the transmitter is a user equipment (UE), and the receiver is an NTN node.

13. The method as recited in claim 12, further comprising:
estimating the TA drift rate of the communication signal prior to the applying.

14. The method as recited in claim 13, wherein the NTN node is a satellite and the estimating the TA drift rate utilizes a satellite ephemeris of the NTN node.

15. The method as recited in claim 12, wherein the applying the phase compensation is performed at the UE, and the applying the phase compensation utilizes a pre-compensation phase error correction with the communication signal.

16. The method as recited in claim 12, wherein the applying the phase compensation is performed at the NTN node, and the applying the phase compensation modifies a reference phase for a demodulation process.

17. The method as recited in claim 12, further comprising:
requesting a location of the UE when the NTN node is applying the phase compensation.

18. The method as recited in claim 12, wherein the communication signal includes a group of single-carrier frequency division multiple access (SC-FDMA) symbols.

19. The method as recited in claim 18, wherein the estimating the TA drift rate utilizes an accumulated phase error compensation over a duration of the communication signal.

20. A non-terrestrial network (NTN) system, comprising:
an NTN node, capable to transceive communications; and
a user equipment (UE), capable to transceive communications with the NTN node, wherein a communication signal from the UE to the NTN node is corrected for a timing advance (TA) drift by applying a compensation method, wherein the compensation method utilizes a location and a relative angle of elevation between the UE and the NTN node.

21-23. (canceled)
